(19) United States
(12) Patent Application Publication
(10) Pub. No.: US 2016/0182165 A1
(43) Pub. Date: Jun. 23, 2016

(54) SENSING METHOD and DEVICE USING RF TO DC CONVERTER

(71) Applicants: Ken Margon, Oakland, CA (US); Pragash Sangaran, Kuala Lumpar (MY)

(72) Inventors: Ken Margon, Oakland, CA (US); Pragash Sangaran, Kuala Lumpar (MY)

(21) Appl. No.: 14/860,690

(22) Filed: Sep. 21, 2015

Related U.S. Application Data
(60) Provisional application No. 62/052,818, filed on Sep. 19, 2014.

(51) Int. Cl. H04B 17/345; H04B 17/20

(52) U.S. Cl. CPC H04B 17/345; H04B 17/20

(57) ABSTRACT

A sensor for detecting electromagnetic radiation and providing valuable information is disclosed. The sensor includes at least one antenna for receiving at least one signal. At least one filter is coupled to the at least one antenna. The at least one filter is configured to remove unwanted noise, out of band signals, or unwanted signals. At least one radio frequency to direct current converter is coupled to the at least one filter. At least one microcontroller is coupled to the at least one radio frequency to direct current converter. The at least one microcontroller is configured to interpret and identify the signals based on unique direct current voltages associated with a particular band and/or technology. Also disclosed is method of detecting electromagnetic radiation to provide valuable information and feedback.

### CROSS-REFERENCE TO RELATED APPLICATION

The present application claims priority to U.S. Provisional Patent Application No. 62/052,818, filed on Sep. 19, 2014, entitled “Sensing Method Using RF to DC Converter” the entire disclosure of which is incorporated by reference herein.

### BACKGROUND OF THE INVENTION

1. Field of Invention

This invention relates generally to electromagnetic (EM) radiation sensors and more specifically, to an improved sensor for detecting devices and objects that emit or disturb EM radiation using radio frequency (RF) to direct current (DC) conversion.

2. Description of Related Art

We are surrounded by a spectrum of EM radiation. The presence of this EM radiation or electromagnetic energy provides a wealth of knowledge waiting to be harnessed. Many sensors have been developed across a range of industries that utilize various detection methods of EM radiation. For example, an inductive sensor can detect metallic objects that are in close proximity to the sensor. Such sensors include metal detectors, devices using eddy current techniques, proximity sensors, and general automated industrial processes. Another example is capacitive sensors, which use capacitive coupling to detect anything that is conductive including the human body. Touchpads and touch screens as used in today's smartphones, tablets, and computer devices are a great example of capacitive sensors. Unfortunately, both inductive and capacitive sensors are limited in their applicable detection range. Because of the limited range of the current state of the art inductive and capacitive sensors, useful information remains largely undetected.

The useful information or data that can be gathered from the spectrum of EM radiation provides real time information and feedback to assist with improvement of everyday life. Many sensors, such as motion detection, surveillance, etc., collect data and provide feedback to ensure a secure living or work environment. These sensors, however, are only tapping into a small portion of the wealth of knowledge present in our everyday surroundings.

Therefore, there exists a need for a sensor capable of detecting useful EM radiation at larger distances from the sensor as well as in close proximity to the sensor to help improve both non-commercial and commercial environments.

### SUMMARY OF THE INVENTION

The present invention overcomes these and other deficiencies of the prior art by providing a sensor for detecting electromagnetic radiation. The sensor comprises at least one antenna for receiving at least one signal. At least one filter is coupled to the at least one antenna. The at least one filter is configured to remove unwanted noise, out of band signals, or unwanted signals. At least one radio frequency to direct current converter is coupled to the at least one filter. At least one microcontroller is coupled to the at least one radio frequency to direct current converter. The at least one microcontroller is configured to interpret and identify signals received by the sensor by identifying a unique direct current voltage associated with a particular band or frequency of EM radiation and the device emitting said particular band or frequency of EM radiation.

The present invention also provides for a method of detecting electromagnetic radiation. The method included the steps of: receiving a signal by at least one antenna; filtering the signal received by the at least on antenna to remove unwanted noise, out of band signals, or unwanted signals; converting the filtered signal from a frequency of electromagnetic radiation to a direct current; and identifying the converted signal by identifying a unique direct current voltage associated with a particular band or frequency of EM radiation and the device emitting said particular band or frequency of EM radiation.

The sensor of the present invention is designed to reduce the number of components, antennas, and cost by providing a generalized front end. The information provided by the sensor of the present invention comes from the RF not the data embedded in the RF carriers, which simplifies and reduces the cost by reducing high speed analog to digital conversion and/or demodulation. Information privacy is maintained because the digital data is lost in the sensor hardware.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 illustrates a sensor according to an embodiment of the invention;

FIG. 2 illustrates a sensor according to another embodiment of the invention;

FIG. 3 illustrates a sensor according to another embodiment of the invention;

FIG. 4 illustrates a sensor according to another embodiment of the invention;

FIG. 5 illustrates a sensor according to another embodiment of the invention;

FIG. 6 illustrates a sensor according to another embodiment of the invention to detect disturbances in EM radiation; and

FIG. 7 illustrates a sensor according to another embodiment of the invention to detect disturbances in EM radiation.

### DETAILED DESCRIPTION OF PREFERRED EMBODIMENTS

Preferred embodiments of the present invention and their advantages may be understood by referring to FIGS. 1-7, wherein like reference numerals refer to like elements.

Although the sensor of the present invention is described in the context of detecting EM radiation or electromagnetic energy as it is emitted from a particular source, it is to be understood that the sensor may be configured to detect disturbances in EM radiation caused by another device, material, object or medium. EM waves are affected by phenomena such as, but not limited to, reflection, refraction, diffraction, absorption, polarization, scattering, and the like. These phenomena affect the power level of the EM wave as it propagates from one medium to another medium. The sensors of the present invention, therefore, may be configured to detect the disturbance of the EM radiation and provide valuable information and feedback.

The sensor of the present invention includes a microcontroller. The microcontroller can be any microcontroller known to those of ordinary skill in the art that may include a processor, non-volatile and volatile memory, and input/output peripherals. Data collected by the microcontroller may be sent without modification to a server, the cloud, etc. In some embodiments, the sensor may send data from a microcontroller to a local computer or personal computer. In still further embodiments, a digital signal processor may be used in place of the microcontroller. The microcontroller interprets and identifies signals received by the sensor by identifying a unique DC voltage associated with a particular band or frequency of EM radiation and the device emitting said particular band or frequency of EM radiation.

The microcontroller of the present invention provides valuable information and feedback based on the data collected by the sensor system. The microcontroller of the present sensor system may be used to detect particular signals or detect disturbances of electromagnetic radiation. In some embodiments, the information collected and/or transmitted by the microcontroller is in the form of identification of a particular band or technology emitting electromagnetic radiation. In other embodiments, the information or feedback may be sent to a separate system such as, but not limited to, a speaker system, a theatre system, a security system, a lighting system, a health monitoring system or any system used to track daily activities and the like. In some embodiments, the sensor system is configured to detect motion. For example, the sensor system may be configured to detect the motion of individual's movements within a space. These movements disturb the electromagnetic radiation within the room, which can be detected by the sensor of the present invention.

The sensor of the present invention includes a converter. The converter may be a radio frequency (RF) converter, a capacitor to DC converter, an inductor to DC converter, or any converter configured to convert EM radiation to DC. Once the EM radiation is converted to DC, it is transmitted to the microcontroller for interpretation and identification of the type of EM radiation and ultimately the device emitting said EM radiation. In some embodiments, the RF to DC converter may be a rectifier operating via diodes. A full-wave rectifier, known to those of ordinary skill in the art, operates by converting the whole of the input waveform to one of constant polarity (positive or negative) at its output. Full-wave rectification converts both polarities of the input waveform to pulsating DC and yields a higher average output voltage. Two diodes and a center tapped transformer, or four diodes in a bridge configuration and any AC source (including a transformer without center tap) are needed. Single semiconductor diodes, double diodes with common cathode or common anode, and four-diode bridges, are manufactured as single components. Once the RF signal is converted to DC, the microcontroller will interpret and identify the signal.

The sensor of the present invention includes a filter. The filter may be a broadband filter, second harmonic filter, or any filter known to those of ordinary skill in the art. The filter removes unwanted noise, out of band signals, or unwanted signals and allows only a preselected band of EM radiation to pass to the converter. In alternative embodiments, the filter may be configured to allow multiple bands of EM radiation to pass to the converter. In some embodiments, the filter is a broadband filter used in a broadband sensor system which is capable of receiving a wide range of frequencies. In alternative embodiments, the filter is band and/or technology specific to the band and/or technology used in that embodiment's specific sensor system. For example, a 3G and/or LTE sensor system would include 3G and/or LTE filters. In still further embodiments, a 2^{nd} harmonic sensor will have a 2^{nd} harmonic filter which is tuned to that frequency. By using a sensor system operating in the 2^{nd} harmonic of a particular signal, the original signal will not be degraded by reducing a collocated receiver's sensitivity or the amount of radiated energy being intentionally radiated by an antenna. In some embodiments, the sensor does not include a filter. In this embodiment without a filter, the antenna is tuned to receive only a particular frequency and terminate (high impedance) at an unwanted frequency.

In some embodiments, the sensor of the present invention includes an antenna. The antenna may be a broadband antenna, a capacitor, an inductor, a ceramic antenna (mounted on PCB), surface mount antennas, any structure designed in PCB material or any conductor material structure. In alternative embodiments, the sensor includes a plurality of antennas, capacitors, inductors, conductor materials, and the like.

FIG. 1 illustrates a sensor 100 according to an embodiment of the present invention. A broadband antenna 110 receives a signal that may be preselected for identification. It is to be understood that the term signal is referring to EM radiation and may be used interchangeably herein. The preselected signal may be, by way of a non-limiting example, a Bluetooth signal, a ZigBee signal, a Wi-Fi signal, a 3G signal, a LTE signal, or the like. In some embodiments, the preselected signal may be a single signal or any combination of multiple signals. The broadband antenna 110 passes the signal to a broadband filter 120. The broadband filter 120 removes out of band signals and unwanted signals. In some embodiments, the sensor may include a plurality of filters that may be specifically designated to filter a particular type of EM radiation. For example, the sensor may include a 3G filter and a Bluetooth filter for a 3G and Bluetooth signal.

The broadband filter 120 passes the filtered signal to a converter 130. The converter 130 may be a RF to DC converter that converts the signal to a DC voltage as described herein. The converted signal is then passed to a microcontroller 140 for interpretation and identification. The microcontroller 140 identifies the signal and signal emitting device (not shown) based upon its unique DC voltage associated with the signal. The microcontroller 140 may collect and store the data or pass the information along to a system for feedback. For example, in the context of a coffee shop, the sensor may be configured to detect 3G and LTE signals. The microcontroller collects this data and identifies areas in the coffee shop where the majority of mobile phone users congregate. As another non-limiting example, the present sensor may be used to detect an individual using a mobile phone in a restricted area such as library.

In some embodiments, the sensor may be configured to detect disturbances in EM radiation caused by another device, material, object and medium. When in this configuration, the sensor can detect any motion such as wirelessly/contactless motion, heart rate and lung rate wireless monitoring, and security monitoring. This configuration may detect finger motion to control a device such as smart phone, smart watch, iPad, etc. The finger motion can be used to select an application in a wireless communications device, play a game without touching a screen of a wireless communications device (just with finger motion in the air) and dial a number by selecting the caller using contactless finger motion. The contactless motion detection may be used to detect whether lights are on in an area at an adequate time for security and monitoring purposes. The contactless motion sensor may be used to detect fire, flood, earth quake, thermal or temperature changes from the ambient temperature, acoustic/sound, flow or fluid velocity, ionizing radiation, subatomic particles, position, angle, displacement, distance, speed, acceleration, proximity, presence, and any motion or disturbance in electromagnetic energy or electromagnetic radiation. It is to be understood that the contactless motion sensor configuration is applicable to FIGS. 1-7.

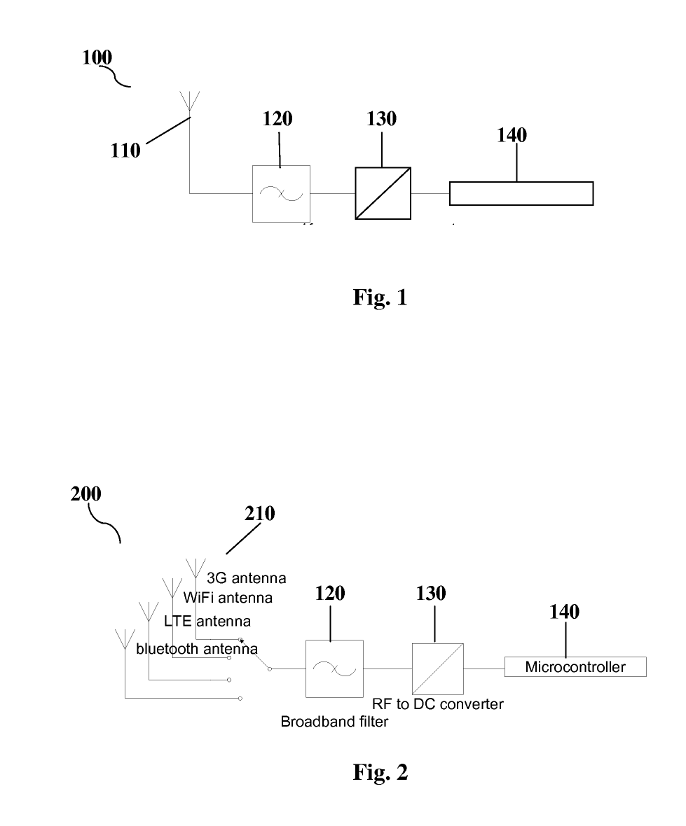

FIG. 2 illustrates an alternative embodiment of the sensor. The sensor 200 includes multiple antennas 210. The sensor 200 includes a switching mechanism (not shown) controlled by the microcontroller 140. The switching mechanism may be programmed, preselected, or manually input into the system 200 by a method known to those of ordinary skill in the art, such as pressing a button or toggling a switch. Based on prior input into the sensor system with regard to which signal(s) are being detected, the microcontroller 140 switches a single antenna ON and the remainder of the multiple antennas OFF. In other cases, a combination of antennas may be switched ON and the remainder OFF. For example, if it is desired to detect Wi-Fi and Bluetooth signals, the system would be input with instruction to turn the Wi-Fi and Bluetooth antennas ON and the 3G and LTE antennas OFF. The broadband filter 120 removes out of band signals and unwanted signals. The broadband filter 120 passes the filtered signal to a converter 130. The converter 130 may be a RF to DC converter that converts the signal to a DC voltage as described herein. The converted signal is then passed to a microcontroller 140 for interpretation and identification. The microcontroller 140 identifies the signal and signal emitting device (not shown) based upon its unique DC voltage associate with the signal. The microcontroller 140 may collect and store the data or pass the information along to a system for feedback.

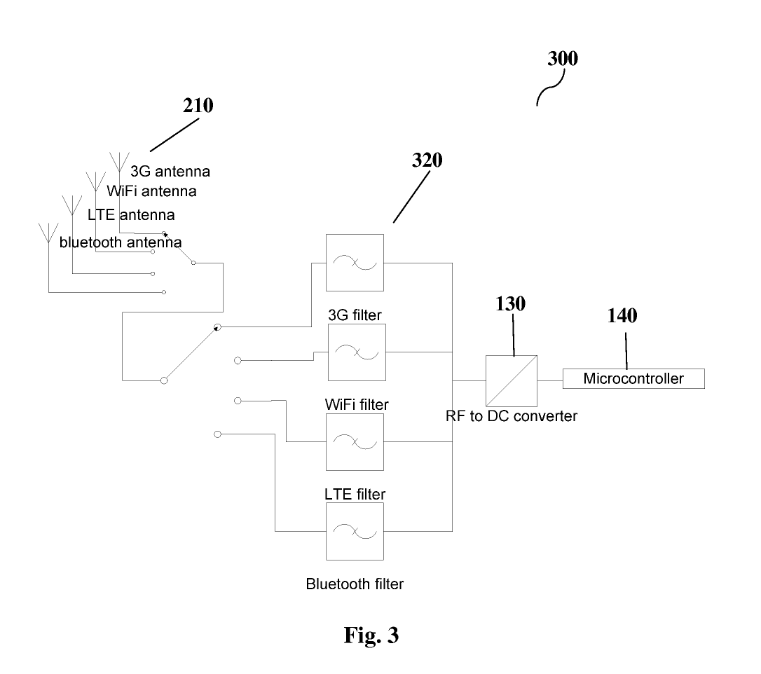

FIG. 3 illustrates an alternative embodiment of the sensor. The sensor 300 includes multiples antennas 210 and multiple filters 320. The multiple filters 320 are specific for a particular band or technology. The sensor 300 functions the same as the sensor 200. The sensor 300 includes a microcontroller 140 controlling a switching mechanism (not shown) that controls the antennas 210 and filters 320 selected based on prior input into the sensor system 300. The multiple filters 320 remove out of band signals and unwanted signals. The multiple filters 320 pass the filtered signal to a converter 130. The converter 130 may be a RF to DC converter that converts the signal to a DC voltage as described herein. The converted signal is then passed to a microcontroller 140 for interpretation and identification. The microcontroller 140 identifies the signal and signal emitting device (not shown) based upon its unique DC voltage associate with the signal. The microcontroller 140 may collect and store the data or pass the information along to a system for feedback.

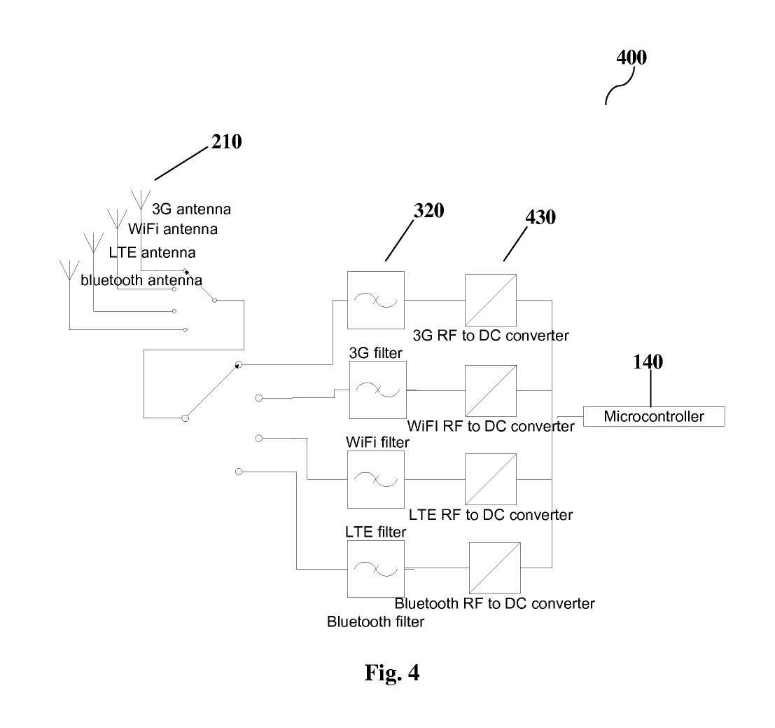

FIG. 4 illustrates an alternative embodiment of the sensor. The sensor 400 includes multiples antennas 210, multiple filters 320, and multiple converters 430. The multiple filters 320 are specific for a particular band or technology. The sensor 400 functions the same as the sensor 300. The sensor 400 includes a microcontroller 140 controlling a switching mechanism (not shown) that controls the antennas 210, filters 320, and converters 430 selected based on prior input into the sensor system 400. In some embodiments, multiple converters are not required because differentiating between different bands or technologies is not necessary because the differentiation has been performed by the multiple antennas and multiple filters. The multiple filters 320 remove out of band signals and unwanted signals. The multiple filters 320 specific for the type of band or technology selected by the microcontroller 140 pass the filtered signal to a converter 430. The converters 430 may be a RF to DC converter that converts the signal to a DC voltage as described herein. The converted signal is then passed to a microcontroller 140 for interpretation and identification. The microcontroller 140 identifies the signal and signal emitting device (not shown) based upon its unique DC voltage associate with the signal. The microcontroller 140 may collect and store the data or pass the information along to a system for feedback.

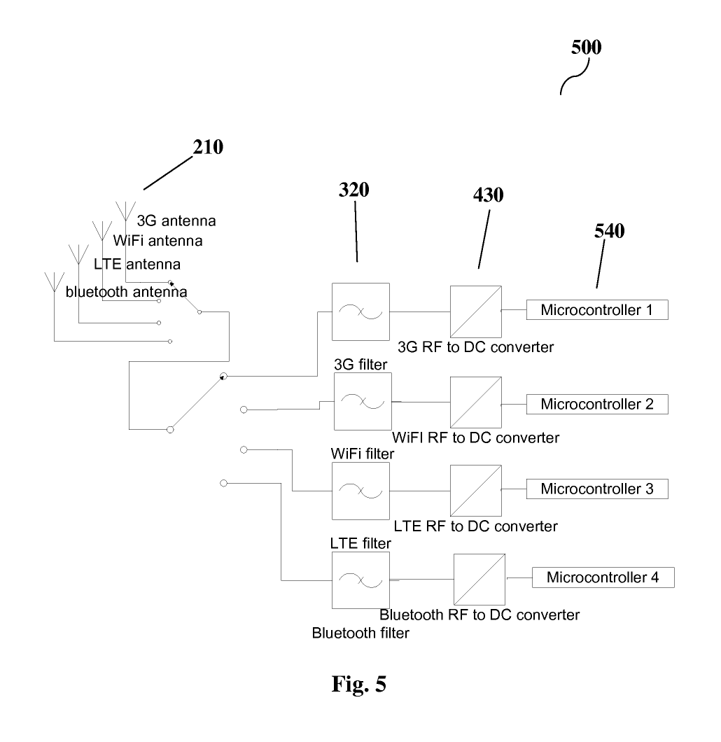

FIG. 5 illustrates an alternative embodiment of the sensor. The sensor 500 includes multiples antennas 210, multiple filters 320, multiple converters 430, and multiple microcontrollers 540. The multiple filters 320 are specific for a particular band or technology. The sensor 500 functions the same as the sensor 400. The sensor 500 includes multiple microcontrollers 540 controlling a switching mechanism (not shown) that controls the antennas 210, filters 320, and converters 430 selected based on prior input into the sensor system 500. In some embodiments, multiple converters are not required because differentiating between different bands or technologies is not necessary because the differentiation has been performed by the multiple antennas and multiple filters. The multiple filters 320 remove out of band signals and unwanted signals. The multiple filters 320 specific for the type of band or technology selected by the microcontroller 540 pass the filtered signal to a converter 430. The converters 430 may be a RF to DC converter that converts the signal to a DC voltage as described herein. The converted signal is then passed to a microcontroller 540 for interpretation and identification. The microcontroller 540 identifies the signal and signal emitting device (not shown) based upon its unique DC voltage associate with the signal. The microcontroller 540 may collect and store the data or pass the information along to a system for feedback.

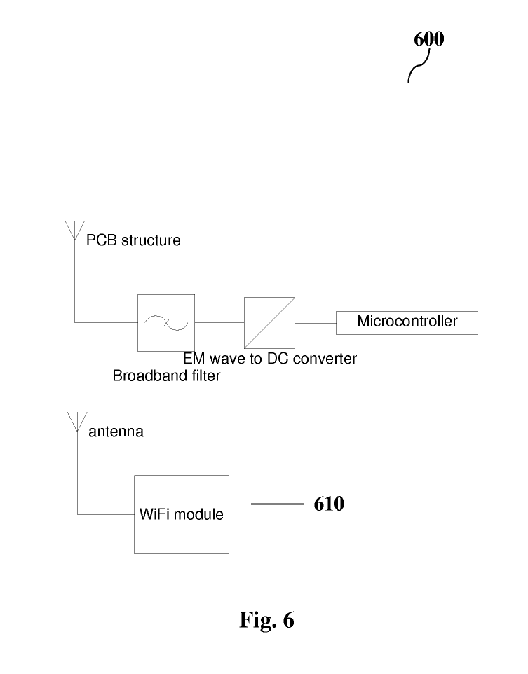

FIG. 6 illustrates an alternative embodiment of the sensor wherein the sensor is configured to detect disturbances to EM radiation. The sensor 600 of this embodiment is configured to detect disturbances in EM radiation. A Wi-Fi signal 610 is present within a space. The sensor 600 detects variations in DC voltage as it relates to the Wi-Fi signal 610, as described above with respect to FIGS. 1-5, to identify the source of the disturbing device, object material, and medium. For example, when the space is in an ideal condition, DC voltage will be a constant. When an individual enters the space, the DC voltage will significantly reduce due to disturbances in the EM radiation. The sensor 600 will alert to the presence of an individual.

In this embodiment, a Wi-Fi signal is described. However, it is to be understood that the signal could be any band or technology, such as, but not limited to, Bluetooth, ZigBee, 3G, LTE, or Wi-Fi. Any material/object/clutter/animal including humans will reflect, refract, diffract, absorb and scatter EM radiation. Due to this phenomena, EM radiation changes in amplitude level (dBm). Thus, changes in EM radiation level changes the DC levels. The system 600, will detect these changes through the RF to DC converter. The microcontroller is then able to identify the disturbing object or material and provide valuable information and feedback according the present invention.

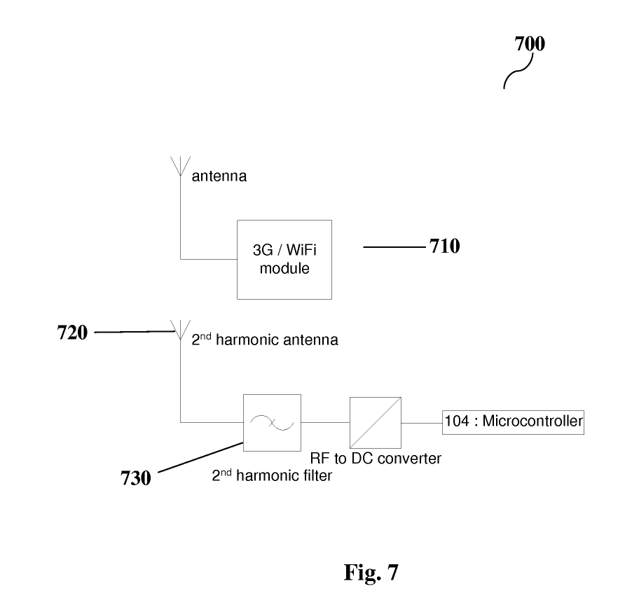

FIG. 7 illustrates an alternative embodiment of the sensor wherein the sensor is configured to detect disturbances to EM radiation. The sensor 700 of this embodiment is configured to detect disturbances in EM radiation. A Wi-Fi or 3G signal 710 is present within a space. The sensor 600 detects variations in DC voltage as it relates to the Wi-Fi or 3G signal 710, as described above with respect to FIGS. 1-5, to identify the source of the disturbing device or object. However, in this embodiment, the sensor 700 includes a 2^{nd} harmonic antenna 720 and a 2^{nd} harmonic filter 730. Because the signal level of a fundamental frequency is directly proportional to the harmonic level, any reduction in the signal level of a fundamental frequency will likewise reduce the 2^{nd} harmonic level. Thus, by detecting the 2^{nd} harmonic level, the sensor 700 can detect if any object/device is disturbing radiation of the EM signal without degrading the transceivers performance in its fundamental frequency. The sensor 700 may also be configured to produce DC current for a battery of the sensor. The sensor 700 reduces the undesired 2^{nd} harmonic level, which will aid the device in certification testing when the sensor 700 is embedded within a RF module.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A sensor for detecting electromagnetic radiation, comprising:
at least one antenna for receiving at least one signal;
at least one radio frequency to direct current converter; and
at least one microcontroller coupled to the at least one radio frequency to direct current converter, wherein the at least one microcontroller is configured to interpret and identify signals received by the sensor by identifying a unique direct current voltage associated with a particular band or frequency of EM radiation and the device emitting said particular band or frequency of EM radiation.

2. The sensor of claim 1, further comprising at least one filter coupled to the at least one antenna, wherein the at least one filter is configured to remove unwanted noise, out of band signals, or unwanted signals, and wherein the at least one radio frequency to direct current converter is coupled to the at least one filter.

3. The sensor of claim 1, wherein the at least one antenna is selected from the group consisting of a capacitor, an inductor, a ceramic antenna, a surface mount antenna, an antenna formed on a substrate, a 3G antenna, a LTE antenna, a Wi-Fi antenna, a Bluetooth antenna, a ZigBee antenna, any structure designed in PCB material, and any conductor material structure.

4. The sensor of claim 2, wherein the at least one filter is a broadband filter configured to filter a broad range of frequencies.

5. The sensor of claim 2, wherein the at least one filter is specific for a 3G signal, a LTE signal, a Wi-Fi signal, a Bluetooth signal, or a ZigBee signal.

6. The sensor of claim 1, wherein the at least one converter is a capacitor to DC converter or an inductor to DC converter.

7. The sensor of claim 1, wherein the microcontroller further comprises a processor, non-volatile and volatile memory, and input/output peripherals.

8. The sensor of claim 1, wherein the microcontroller is configured to detect disturbances to electromagnetic radiation or electromagnetic energy.

9. The sensor of claim 8, wherein the disturbances to the electromagnetic radiation or electromagnetic energy are reflection, refraction, diffraction, absorption, polarization, or scattering.

10. The sensor of claim 1, wherein the microcontroller is configured to be coupled to at least one system selected from the group consisting of a speaker system, a theatre system, a security system, a lighting system, and a health monitoring system.

11. The sensor of claim 10, wherein the microcontroller provides feedback to the selected at least one system to control or alter the functioning of the selected at least one system.

12. The sensor of claim 1, wherein the microcontroller is configured to detect motion in a space, wherein said motion disturbs electromagnetic radiation in the space.

13. The sensor of claim 1, wherein the antenna and the filter is configured to detect a harmonic of a fundamental frequency.

14. The sensor of claim 13, wherein the harmonic is the second harmonic of a fundamental frequency.

15. A method for detecting electromagnetic radiation, including the steps of:
receiving a signal by at least one antenna;
converting the filtered signal from a frequency of electromagnetic radiation to a direct current; and
identifying the converted signal by identifying a unique direct current voltage associated with a particular band or frequency of EM radiation and the device emitting said particular band or frequency of EM radiation.

16. The method of claim 15, further including the step of:
filtering the signal received by the at least on antenna to remove unwanted noise, out of band signals, or unwanted signals.

17. The method of claim 15, further including the step of:
detecting disturbances to electromagnetic radiation, wherein an object or device disturbs the DC voltage present in a space.

18. The method of claim 17, wherein motion of the object or device is detected in the space.

19. The method of claim 15, wherein the converted signal is a harmonic of a fundamental frequency.

20. The method of claim 19, wherein the harmonic is the second harmonic of a fundamental frequency.

21. The method of claim 15, further including the steps of:
storing metadata associated with the identified converted signal; and
providing feedback to at least one system selected from the group consisting of a speaker system, a theatre system, a security system, a lighting system, and a health monitoring system.

22. The method of claim 21, further including the step of:
controlling or altering the functions of the selected at least one system.

23. A sensor for detecting electromagnetic radiation, comprising:
at least one antenna for receiving at least one signal;
at least one filter coupled to the at least one antenna, wherein the at least one filter is configured to remove unwanted noise, out of band signals, or unwanted signals;
at least one radio frequency to direct current converter coupled to the at least one filter; and
at least one microcontroller coupled to the at least one radio frequency to direct current converter, wherein the at least one microcontroller is configured to interpret and identify signals received by the sensor by identifying a unique direct current voltage associated with a particular band or frequency of EM radiation and the device emitting said particular band or frequency of EM radiation.
